(19) United States
(12) Patent Application Publication
(10) Pub. No.: US 2021/0143469 A1
(43) Pub. Date: May 13, 2021

(54) METHOD FOR PRODUCING SULFIDE SOLID ELECTROLYTE MATERIAL

(71) Applicant: TOYOTA JIDOSHA KABUSHIKI KAISHA, Toyota-shi (JP)

(72) Inventor: Keiichi MINAMI, Sunto-gun (JP)

(73) Assignee: TOYOTA JIDOSHA KABUSHIKI KAISHA, Toyota-shi (JP)

(21) Appl. No.: 17/093,780

(22) Filed: Nov. 10, 2020

(30) Foreign Application Priority Data
Nov. 12, 2019 (JP) 2019-204593

(51) Int. Cl. H01M 10/0562; H01M 10/0525; C03C 10/00; C03C 3/32

(52) U.S. Cl. CPC H01M 10/0562; H01M 10/0525; H01M 2300/0068; C03C 3/321; C03C 10/00

(57) ABSTRACT

A method for producing a sulfide solid electrolyte material, which is configured to allow the crystallization of a sulfide glass at low temperature. Provided is a method for producing a sulfide solid electrolyte material, the method comprising: amorphizing a raw material composition containing Li₂S, P₂S₅, LiI, LiBr, a potassium-containing compound and Li₃N to obtain a sulfide glass, and crystallizing the sulfide glass by hot-pressing the sulfide glass, wherein, when a first crystallization temperature of the sulfide glass is determined as X, and a second crystallization temperature of the sulfide glass is determined as Y, the first crystallization temperature X of the sulfide glass is 171° C. or less, and a temperature difference (Y−X) between the second crystallization temperature Y and the first crystallization temperature X is 75° C. or more.

### CROSS-REFERENCE TO RELATED APPLICATION(S)

This application claims the benefit based on Patent Application No. JP2019-204593 filed Nov. 12, 2019, the contents of which is incorporated herein by reference.

### TECHNICAL FIELD

The disclosure relates to a method for producing a sulfide solid electrolyte material.

### BACKGROUND

In recent years, with the rapid spread of IT and communication devices such as personal computers, camcorders and cellular phones, great importance has been attached to the development of batteries that is usable as the power source of such devices. In the automobile industry, etc., high-power and high-capacity batteries for electric vehicles and hybrid vehicles are under development.

Of various kinds of batteries, an all-solid-state battery has attracted attention since it uses a solid electrolyte instead of an electrolytic solution containing an organic solvent as an electrolyte disposed between the cathode and the anode. Also, a sulfide solid electrolyte material is known as the solid electrolyte.

For the purpose of increasing the lithium ion conductivity of a sulfide solid electrolyte material, Patent Literature 1 discloses a sulfide solid electrolyte material production method comprising the steps of amorphizing a raw material composition that contains Li₂S, P₂S₅, LiI and LiBr and heating the raw material composition at a temperature of 195° C. or more.

Patent Literature 1: Japanese Patent Application Laid-Open No. 2015-011898

In the technique described in Patent Literature 1, when the raw material composition is amorphized to obtain a sulfide glass, and the sulfide glass and an active material are hot-pressed to crystalize the sulfide glass, the sulfide glass needs to be heated at high temperature. Accordingly, there is a problem in that a resistive layer is formed in an interface obtained by crystallizing the sulfide solid electrolyte material and the active material, and a high power output battery cannot be produced.

### SUMMARY

The disclosed embodiments were achieved in light of the above circumstances. An object of the disclosed embodiments is to provide a method for producing a sulfide solid electrolyte material, which is configured to allow the crystallization of a sulfide glass at low temperature.

In a first embodiment, there is provided a method for producing a sulfide solid electrolyte material, the method comprising:

amorphizing a raw material composition containing Li₂S, P2S₅, LiI, LiBr, a potassium-containing compound and Li₃N to obtain a sulfide glass, and

crystallizing the sulfide glass by hot-pressing the sulfide glass,

wherein, when a first crystallization temperature of the sulfide glass is determined as X, and a second crystallization temperature of the sulfide glass is determined as Y, the first crystallization temperature X of the sulfide glass is 171° C. or less, and a temperature difference (Y−X) between the second crystallization temperature Y and the first crystallization temperature X is 75° C. or more.

In the method for producing the sulfide solid electrolyte material according to the disclosed embodiments, the potassium-containing compound may be at least one selected from the group consisting of K₂S and KI.

In the method for producing the sulfide solid electrolyte material according to the disclosed embodiments, the potassium-containing compound may be KI.

According to the disclosed embodiments, the method for producing the sulfide solid electrolyte material is provided, which is configured to allow the crystallization of the sulfide glass at low temperature.

### DETAILED DESCRIPTION

The method for producing the sulfide solid electrolyte material according to the disclosed embodiments, is a method for producing a sulfide solid electrolyte material, the method comprising:

amorphizing a raw material composition containing Li₂S, P₂S₅, LiI, LiBr, a potassium-containing compound and Li₃N to obtain a sulfide glass, and
crystallizing the sulfide glass by hot-pressing the sulfide glass,
wherein, when a first crystallization temperature of the sulfide glass is determined as X, and a second crystallization temperature of the sulfide glass is determined as Y, the first crystallization temperature X of the sulfide glass is 171° C. or less, and a temperature difference (Y−X) between the second crystallization temperature Y and the first crystallization temperature X is 75° C. or more.

The performance of the battery comprising the sulfide solid electrolyte material, is largely influenced by the size of the area of the contact interface between the active material and the sulfide solid electrolyte material. To increase the area of the interface, for example, hot-press densification of a mixed material containing an active material and the amorphized raw material composition (hereinafter may be referred to as “sulfide glass”), hot-press densification of a laminate of an active material-containing layer and a sulfide glass-containing layer, may be employed. For the densification of the mixed material, the laminate, etc., it is important to undergo the process of precipitating high ion conducting crystals of the sulfide solid electrolyte material, using the softening and fusing effects produced by the hot pressing of the sulfide glass. However, there is the following problem: since the current sulfide glass has a high crystallization temperature, as described above, the sulfide glass reacts with the active material (especially the cathode active material) during the hot pressing, thereby forming the resistive layer between the sulfide glass and the active material.

It was found that the high ion conducting crystals can be stably precipitated even in a low temperature heat treatment, by adding the potassium-containing compound, which is effective in lowering the first crystallization temperature of the sulfide glass, and the Li₃N, which is effective in achieving both the stable precipitation of the high ion conducting crystals by shifting the second crystallization temperature to the high temperature side, to the raw material composition of the Li₂S-P₂S₅-LiI—LiBr-based sulfide solid electrolyte material and/or by replacing the raw material composition with the potassium-containing compound and the Li₃N. In addition, it was found that the first crystallization temperature of the sulfide glass can be further lowered and the high ion conducting crystals can be stably precipitated by using KI as the potassium-containing compound for lowering the first crystallization temperature.

The method for producing the sulfide solid electrolyte material according to the disclosed embodiments comprises at least (1) the amorphizing step and (2) the crystallizing step.

### (1) Amorphizing Step

This is a step of amorphizing a raw material composition containing Li₂S, P₂S₅, LiI, LiBr, a potassium-containing compound and Li₃N to obtain a sulfide glass.

The potassium-containing compound is not particularly limited, as long as it is a compound containing a potassium element. As the potassium-containing compound, examples include, but are not limited to, K₂S and KI. From the viewpoint of lowering the first crystallization temperature of the sulfide glass, the potassium-containing compound may be KI. The potassium-containing compound may be one kind of potassium-containing compound or a combination of two or more kinds of potassium-containing compounds.

When the first crystallization temperature of the sulfide glass obtained by amorphizing the raw material composition is determined as X, and the second crystallization temperature of the sulfide glass is determined as Y, the first crystallization temperature X is 171° C. or less, and the temperature difference (Y−X) between the second crystallization temperature Y and the first crystallization temperature X is 75° C. or more.

From the viewpoint of low temperature crystallization of the sulfide glass, the first crystallization temperature X of the sulfide glass may be 144° C. or more and 171° C. or less.

From the viewpoint of stably precipitating the high ion conducting crystals, the second crystallization temperature Y of the sulfide glass may be 226° C. or more and 263° C. or less. Since the temperature difference (Y−X) is 75° C. or more, in the crystallization of the sulfide glass, the primary crystal stabilization temperature range of the sulfide glass can be widened, and the high ion conducting crystals can be more stably precipitated.

The first crystallization temperature X and second crystallization temperature Y of the sulfide glass may be measured by the following method, for example. A DTA curve is obtained by differential thermal analysis (DTA) of the sulfide glass. The temperature corresponding to the top of the first exothermic peak observed by observing the DTA curve from the low temperature side to the high temperature side, is determined as the first crystallization temperature, and the temperature corresponding to the top of the second exothermic peak is determined as the second crystallization temperature.

The percentage of the raw materials in the raw material composition is not particularly limited, as long as the raw material composition is such a raw material composition, that the first crystallization temperature X of the sulfide glass obtained by amorphizing the raw material composition is 171° C. or less, and the temperature difference (Y−X) between the second crystallization temperature Y and the first crystallization temperature X is 75° C. or more.

From the viewpoint of making the sulfide solid electrolyte material into a highly chemically stable material, the total percentage of the Li₂S and P₂S₅ in the raw material composition when the whole raw material composition is determined as 100 mol %, may be in a range of from 50 mol % to 85 mol %.

The total percentage of the LiI and LiBr in the raw material composition when the whole raw material composition is determined as 100 mol %, is not particularly limited, as long as the desired sulfide solid electrolyte material is obtained. For example, the total percentage may be in a range of from 10 mol % to 35 mol %.

The percentage of the Li₃N in the raw material composition when the whole raw material composition is determined as 100 mol %, is not particularly limited, as long as the desired sulfide solid electrolyte material is obtained. From the viewpoint of shifting the second crystallization temperature of the sulfide glass to the higher temperature side, the percentage of the Li₃N may be in a range of from 1.0 mol % to 10.0 mol %, for example.

The percentage of the potassium-containing compound in the raw material composition when the whole raw material composition is determined as 100 mol %, is not particularly limited, as long as the desired sulfide solid electrolyte material is obtained. From the viewpoint of further lowering the first crystallization temperature of the sulfide glass, the percentage of the potassium-containing compound may be in a range of from 3.0 mol % to 11.0 mol %, for example.

As the method for amorphizing the raw material composition, examples include, but are not limited to, mechanical milling and a melt-quenching method. The method may be mechanical milling, from the point of view that the raw material composition can be amorphized at normal temperature, and the production process can be simplified. The mechanical milling may be dry mechanical milling or wet mechanical milling. The mechanical milling may be wet mechanical milling. This is because the attachment of the raw material composition to the inner wall surface of a container, etc., can be prevented, and a sulfide glass with higher amorphous nature can be obtained.

For example, by the presence or absence of a diffraction peak in a given range of a spectrum obtained by X-ray diffraction (XRD) measurement, and by the presence or absence of a peak in a given range of a spectrum obtained by Raman spectroscopy measurement, it is possible to determine whether the raw material composition was formed into the sulfide glass or not.

The mechanical milling is not particularly limited, as long as it is a method for mixing the raw material composition by applying mechanical energy thereto. The mechanical milling may be carried out by, for example, a ball mill, a vibrating mill, a turbo mill, mechanofusion, or a disk mill. The mechanical milling may be carried out by a ball mill, or it may be carried out by a planetary ball mill. This is because the desired sulfide glass can be efficiently obtained.

The conditions of the mechanical milling are determined so that the desired sulfide glass can be obtained. For example, in the case of using the planetary ball mill, the raw material composition and grinding balls are put in a container, and mechanical milling is carried out at a predetermined rotational frequency for a predetermined time. In general, the larger the rotational frequency, the faster the production speed of the sulfide glass, and the longer the treatment time, the higher the conversion rate of the raw material composition into the sulfide glass. In the case of using the planetary ball mill, the plate rotational frequency may be in a range of from 200 rpm to 500 rpm, for example. In the case of using the planetary ball mill, the mechanical milling time may be in a range of from 1 hour to 100 hours, for example. In particular, the mechanical milling time may be in a range of from 1 hour to 50 hours. As the material of the container and grinding balls used in the ball mill, examples include, but are not limited to, ZrO₂ and Al₂O₃. The diameter of the grinding balls may be in a range of from 1 mm to 20 mm, for example.

The mechanical milling may be carried out in an inert gas atmosphere such as Ar gas atmosphere.

A liquid is used for wet mechanical milling. The liquid is not particularly limited and may be a liquid that does not produce hydrogen sulfide in a reaction with the raw material composition. Aprotic liquids can be broadly classified into polar and non-polar aprotic liquids.

The polar aprotic liquid is not particularly limited. As the polar aprotic liquid, examples include, but are not limited to, ketones such as acetone; nitriles such as acetonitrile; amides such as N,N-dimethylformamide (DMF); and sulfoxides such as dimethylsulfoxide (DMSO).

An example of the non-polar aprotic liquid is an alkane that is liquid at normal temperature (25° C.). The alkane may be a chain alkane or a cyclic alkane. The carbon number of the chain alkane may be 5 or more, for example. The upper limit of the carbon number of the chain alkane is not particularly limited, as long as the chain alkane is liquid at normal temperature. As the chain alkane, examples include, but are not limited to, pentane, hexane, heptane, octane, nonane, decane, undecane, dodecane and paraffin. The chain alkane may have a branch. As the cyclic alkane, examples include, but are not limited to, cyclopentane, cyclohexane, cycloheptane, cyclooctane and cycloparaffin.

As the non-polar aprotic liquid, examples also include, but are not limited to, aromatic hydrocarbons such as benzene, toluene and xylene; chain ethers such as diethyl ether and dimethyl ether; cyclic ethers such as tetrahydrofuran; alkyl halides such as chloroform, methyl chloride and methylene chloride; esters such as ethyl acetate; and fluorine compounds such as benzene fluoride, heptane fluoride, 2,3-dihydroperfluoropentane, and 1,1,2,2,3,3,4-heptafluorocyclopentane. The amount of the added liquid is not particularly limited, and it may be such an amount that the desired sulfide solid electrolyte material can be obtained.

### (2) Crystallizing Step

This is a step of crystallizing the sulfide glass by hot-pressing the sulfide glass.

In the crystallizing step, the temperature of the pressing machine during the hot pressing may be equal to or more than the first crystallization temperature X of the sulfide glass. The upper limit of the temperature of the pressing machine during the hot pressing is not particularly limited. From the viewpoint of crystallization at low temperature, the upper limit of the temperature of the pressing machine may be equal to or less than the second crystallization temperature Y, for example.

The sulfide glass hot-pressing time is not particularly limited, as long as the desired glass-ceramics is obtained. For example, it may be in a range of from one minute to 24 hours, or it may be in a range of from one minute to 10 hours.

The hot-pressing may be carried out in an inert gas atmosphere such as Ar gas atmosphere, in a reduced-pressure atmosphere, or in a vacuum. This is because a deterioration (e.g., oxidation) of the sulfide solid electrolyte material can be prevented.

In general, the sulfide solid electrolyte material obtained by the disclosed embodiments is glass-ceramics. Glass-ceramics is a material obtained by crystallizing sulfide glass. For example, by X-ray diffraction measurement or the like, it is possible to check whether sulfide glass is glass-ceramics or not. Also, sulfide glass refers to a material synthesized by amorphizing a raw material composition, and it means not only “glass” in a strict sense, for which crystal periodicity is not observed by X-ray diffraction measurement or the like, but also materials in a general sense, which are synthesized by amorphization by mechanical milling or the like. Accordingly, even when a material is observed by X-ray diffraction measurement or the like and a peak derived from a raw material (such as LiI) is observed, the material corresponds to sulfide glass as long as it is a material synthesized by amorphization.

As the form of the sulfide solid electrolyte material obtained by the disclosed embodiments, examples include, but are not limited to, a particulate form. The average particle diameter (D₅₀) of the sulfide solid electrolyte material in the particulate form may be in a range of from 0.1 μm to 50 μm. The Li ion conductivity of the sulfide solid electrolyte material may be high. For example, the Li ion conductivity of the sulfide solid electrolyte material at normal temperature may be 1×10⁻⁴ S/cm or more, or it may be 1×10⁻³ S/cm or more.

The sulfide solid electrolyte material obtained by the disclosed embodiments can be used in any intended application that needs Li ion conductivity. In particular, the sulfide solid electrolyte material may be used in a battery. Also, the disclosed embodiments can provide a method for producing a lithium solid-state battery comprising the above-described sulfide solid electrolyte material. The sulfide solid electrolyte material may be used in a cathode layer, an anode layer, or a solid electrolyte layer.

The present disclosure is not limited to the above-mentioned embodiments. The above-mentioned embodiments are examples, and any that has the substantially same essential features as the technical ideas described in the claims of the present disclosure and exerts the same effects and advantages as the embodiments is included in the technical scope of the present disclosure.

### EXAMPLES

The embodiments described herein will be further clarified by the following examples. Unless otherwise noted, operations such as weighing, synthesizing and drying were carried out under an Ar atmosphere.

### Comparative Example 1

As starting raw materials, 0.5503 g of Li₂S (manufactured by Furuuchi Chemical Corporation), 0.8874 g of P2S₅ (manufactured by Aldrich), 0.2850 g of LiI (manufactured by Kojundo Chemical Laboratory Co., Ltd.) and 0.2773 g of LiBr (manufactured by Kojundo Chemical Laboratory Co., Ltd.) were weighed out and mixed in an agate mortar for 5 minutes. The mixture was put in a zirconia pot (45 ml) containing 53 g of zirconia balls that were 5 mm in diameter. Then, 4 g of dehydrated heptane (manufactured by Kanto Chemical Industry Co., Ltd.) was put in the pot, and the pot was capped. The zirconia pot was installed in a planetary ball mill (P7 manufactured by Fritsch). The mixture was subjected to mechanical milling for 20 hours at a plate rotational frequency of 500 rpm. Then, the mixture was dried at 110° C. for one hour for removal of the heptane from the mixture, thereby obtaining the sulfide glass of Comparative Example 1.

Next, 0.5 g of the obtained sulfide glass of Comparative Example 1 was hot-pressed at the first crystallization temperature of the sulfide glass, thereby obtaining the sulfide solid electrolyte material of Comparative Example 1, which was glass-ceramics.

### Comparative Example 2

The sulfide glass of Comparative Example 2 was obtained in the same manner as Comparative Example 1, except that 0.5452 g of Li₂S (manufactured by Furuuchi Chemical Corporation), 0.8851 g of P₂S₅ (manufactured by Aldrich), 0.2842 g of LiI (manufactured by Kojundo Chemical Laboratory Co., Ltd.), 0.2766 g of LiBr (manufactured by Kojundo Chemical Laboratory Co., Ltd.) and 0.0088 g of K₂S (manufactured by Kojundo Chemical Laboratory Co., Ltd.) were used as starting raw materials.

Next, 0.5 g of the obtained sulfide glass of Comparative Example 2 was hot-pressed at the first crystallization temperature of the sulfide glass, thereby obtaining the sulfide solid electrolyte material of Comparative Example 2, which was glass-ceramics.

### Comparative Example 3

The sulfide glass of Comparative Example 3 was obtained in the same manner as Comparative Example 1, except that 0.5402 g of Li₂S (manufactured by Furuuchi Chemical Corporation), 0.8829 g of P₂S₅ (manufactured by Aldrich), 0.2835 g of LiI (manufactured by Kojundo Chemical Laboratory Co., Ltd.), 0.2759 g of LiBr (manufactured by Kojundo Chemical Laboratory Co., Ltd.) and 0.0175 g of K₂S (manufactured by Kojundo Chemical Laboratory Co., Ltd.) were used as starting raw materials.

Next, 0.5 g of the obtained sulfide glass of Comparative Example 3 was hot-pressed at the first crystallization temperature of the sulfide glass, thereby obtaining the sulfide solid electrolyte material of Comparative Example 3, which was glass-ceramics.

### Comparative Example 4

The sulfide glass of Comparative Example 4 was obtained in the same manner as Comparative Example 1, except that 0.5302 g of Li₂S (manufactured by Furuuchi Chemical Corporation), 0.8784 g of P₂S₅ (manufactured by Aldrich), 0.2821 g of LiI(manufactured by Kojundo Chemical Laboratory Co., Ltd.), 0.2745 g of LiBr (manufactured by Kojundo Chemical Laboratory Co., Ltd.) and 0.0349 g of K₂S (manufactured by Kojundo Chemical Laboratory Co., Ltd.) were used as starting raw materials.

Next, 0.5 g of the obtained sulfide glass of Comparative Example 4 was hot-pressed at the first crystallization temperature of the sulfide glass, thereby obtaining the sulfide solid electrolyte material of Comparative Example 4, which was glass-ceramics.

### Comparative Example 5

The sulfide glass of Comparative Example 5 was obtained in the same manner as Comparative Example 1, except that 0.5203 g of Li₂S (manufactured by Furuuchi Chemical Corporation), 0.8739 g of P₂S₅ (manufactured by Aldrich), 0.2806 g of LiI (manufactured by Kojundo Chemical Laboratory Co., Ltd.), 0.2731 g of LiBr (manufactured by Kojundo Chemical Laboratory Co., Ltd.) and 0.0520 g of K₂S (manufactured by Kojundo Chemical Laboratory Co., Ltd.) were used as starting raw materials.

Next, 0.5 g of the obtained sulfide glass of Comparative Example 5 was hot-pressed at the first crystallization temperature of the sulfide glass, thereby obtaining the sulfide solid electrolyte material of Comparative Example 5, which was glass-ceramics.

### Comparative Example 6

The sulfide glass of Comparative Example 6 was obtained in the same manner as Comparative Example 1, except that 0.5360 g of Li₂S (manufactured by Furuuchi Chemical Corporation), 0.8910 g of P₂S₅ (manufactured by Aldrich), 0.2861 g of LiI (manufactured by Kojundo Chemical Laboratory Co., Ltd.), 0.2785 g of LiBr (manufactured by Kojundo Chemical Laboratory Co., Ltd.) and 0.0084 g of Li₃N (manufactured by Kojundo Chemical Laboratory Co., Ltd.) were used as starting raw materials.

Next, 0.5 g of the obtained sulfide glass of Comparative Example 6 was hot-pressed at the first crystallization temperature of the sulfide glass, thereby obtaining the sulfide solid electrolyte material of Comparative Example 6, which was glass-ceramics.

### Comparative Example 7

The sulfide glass of Comparative Example 7 was obtained in the same manner as Comparative Example 1, except that 0.5264 g of Li₂S (manufactured by Furuuchi Chemical Corporation), 0.8935 g of P₂S₅ (manufactured by Aldrich), 0.2869 g of LiI (manufactured by Kojundo Chemical Laboratory Co., Ltd.), 0.2792 g of LiBr (manufactured by Kojundo Chemical Laboratory Co., Ltd.) and 0.0140 g of Li₃N (manufactured by Kojundo Chemical Laboratory Co., Ltd.) were used as starting raw materials.

Next, 0.5 g of the obtained sulfide glass of Comparative Example 7 was hot-pressed at the first crystallization temperature of the sulfide glass, thereby obtaining the sulfide solid electrolyte material of Comparative Example 7, which was glass-ceramics.

### Comparative Example 8

The sulfide glass of Comparative Example 8 was obtained in the same manner as Comparative Example 1, except that 0.5021 g of Li₂S (manufactured by Furuuchi Chemical Corporation), 0.8996 g of P₂S₅ (manufactured by Aldrich), 0.2889 g of LiI (manufactured by Kojundo Chemical Laboratory Co., Ltd.), 0.2812 g of LiBr (manufactured by Kojundo Chemical Laboratory Co., Ltd.) and 0.0282 g of Li₃N (manufactured by Kojundo Chemical Laboratory Co., Ltd.) were used as starting raw materials.

Next, 0.5 g of the obtained sulfide glass of Comparative Example 8 was hot-pressed at the first crystallization temperature of the sulfide glass, thereby obtaining the sulfide solid electrolyte material of Comparative Example 8, which was glass-ceramics.

### Comparative Example 9

The sulfide glass of Comparative Example 9 was obtained in the same manner as Comparative Example 1, except that 0.4526 g of Li₂S (manufactured by Furuuchi Chemical Corporation), 0.9122 g of P₂S₅ (manufactured by Aldrich), 0.2929 g of LiI (manufactured by Kojundo Chemical Laboratory Co., Ltd.), 0.2851 g of LiBr (manufactured by Kojundo Chemical Laboratory Co., Ltd.) and 0.0572 g of Li₃N (manufactured by Kojundo Chemical Laboratory Co., Ltd.) were used as starting raw materials.

Next, 0.5 g of the obtained sulfide glass of Comparative Example 9 was hot-pressed at the first crystallization temperature of the sulfide glass, thereby obtaining the sulfide solid electrolyte material of Comparative Example 9, which was glass-ceramics.

For each of the raw materials of the raw material compositions used in Comparative Examples 1 to 9, the mass, the mol corresponding thereto, and the mol % when the whole raw material composition was determined as 100 mol %, are shown in Table 1.

TABLE 1

| | Unit | Li₂S | P₂S₅ | LiI | LiBr | Li₃N | K₂S | Kl | total |
|---|---|---|---|---|---|---|---|---|---|
| Comparative | g | 0.5503 | 0.8874 | 0.2850 | 0.2773 | — | — | — | 2 |
| Example 1 | mol | 0.0117 | 0.0020 | 0.0021 | 0.0032 | — | — | — | 0.0190 |
| | mol % | 61.6 | 10.5 | 11.2 | 16.8 | — | — | — | 100 |
| Comparative | g | 0.5452 | 0.8851 | 0.2842 | 0.2766 | — | 0.0088 | — | 1.9999 |
| Example 2 | mol | 0.0116 | 0.0020 | 0.0021 | 0.0032 | — | 0.0001 | — | 0.0190 |
| | mol % | 61.1 | 10.5 | 11.2 | 16.8 | — | 0.4 | — | 100 |
| Comparative | g | 0.5402 | 0.8829 | 0.2835 | 0.2759 | — | 0.0175 | — | 0.0189 |
| Example 3 | mol | 0.0115 | 0.0020 | 0.0021 | 0.0032 | — | 0.0002 | — | 0.0189 |
| | mol % | 60.7 | 10.5 | 11.2 | 16.8 | — | 0.8 | — | 100 |
| Comparative | g | 0.5302 | 0.8784 | 0.2821 | 0.2745 | — | 0.0349 | — | 2.0001 |
| Example 4 | mol | 0.0113 | 0.0020 | 0.0021 | 0.0032 | — | 0.0003 | — | 0.0189 |
| | mol % | 59.9 | 10.5 | 11.2 | 16.8 | — | 1.7 | — | 100 |
| Comparative | g | 0.5203 | 0.8739 | 0.2806 | 0.2731 | — | 0.0520 | — | 1.9999 |
| Example 5 | mol | 0.0111 | 0.0020 | 0.0021 | 0.0031 | — | 0.0005 | — | 0.0188 |
| | mol % | 59.1 | 10.5 | 11.2 | 16.8 | — | 2.5 | — | 100 |
| Comparative | g | 0.5360 | 0.8910 | 0.2861 | 0.2785 | 0.0084 | — | — | 2 |
| Example 6 | mol | 0.0114 | 0.0020 | 0.0021 | 0.0032 | 0.0002 | — | — | 0.0190 |
| | mol % | 60.1 | 10.5 | 11.2 | 16.9 | 1.3 | — | — | 100 |
| Comparative | g | 0.5264 | 0.8935 | 0.2869 | 0.2792 | 0.0140 | — | — | 2 |
| Example 7 | mol | 0.0112 | 0.0020 | 0.0021 | 0.0032 | 0.0004 | — | — | 0.0190 |
| | mol % | 59.1 | 10.6 | 11.3 | 16.9 | 2.1 | — | — | 100 |
| Comparative | g | 0.5021 | 0.8996 | 0.2889 | 0.2812 | 0.0282 | — | — | 2 |
| Example 8 | mol | 0.0107 | 0.0020 | 0.0022 | 0.0032 | 0.0008 | — | — | 0.0189 |
| | mol % | 56.5 | 10.7 | 11.4 | 17.1 | 4.3 | — | — | 100 |
| Comparative | g | 0.4526 | 0.9122 | 0.2929 | 0.2851 | 0.0572 | — | — | 2 |
| Example 9 | mol | 0.0096 | 0.0021 | 0.0022 | 0.0033 | 0.0016 | — | — | 0.0188 |
| | mol % | 51.3 | 10.9 | 11.6 | 17.5 | 8.7 | — | — | 100 |

### Example 1

The sulfide glass of Example 1 was obtained in the same manner as Comparative Example 1, except that 0.4937 g of Li₂S (manufactured by Furuuchi Chemical Corporation), 0.8654 g of P2S₅ (manufactured by Aldrich), 0.2779 g of LiI (manufactured by Kojundo Chemical Laboratory Co., Ltd.), 0.2705 g of LiBr (manufactured by Kojundo Chemical Laboratory Co., Ltd.), 0.0217 g of Li₃N (manufactured by Kojundo Chemical Laboratory Co., Ltd.) and 0.0708 g of K₂S (manufactured by Kojundo Chemical Laboratory Co., Ltd.) were used as starting raw materials.

Next, 0.5 g of the obtained sulfide glass of Example 1 was hot-pressed at the first crystallization temperature of the sulfide glass, thereby obtaining the sulfide solid electrolyte material of Example 1, which was glass-ceramics.

### Example 2

The sulfide glass of Example 2 was obtained in the same manner as Comparative Example 1, except that 0.4877 g of Li₂S (manufactured by Furuuchi Chemical Corporation), 0.8549 g of P2S₅ (manufactured by Aldrich), 0.2745 g of LiI (manufactured by Kojundo Chemical Laboratory Co., Ltd.), 0.2672 g of LiBr (manufactured by Kojundo Chemical Laboratory Co., Ltd.), 0.0214 g of Li₃N (manufactured by Kojundo Chemical Laboratory Co., Ltd.) and 0.0942 g of K₂S (manufactured by Kojundo Chemical Laboratory Co., Ltd.) were used as starting raw materials.

Next, 0.5 g of the obtained sulfide glass of Example 2 was hot-pressed at the first crystallization temperature of the sulfide glass, thereby obtaining the sulfide solid electrolyte material of Example 2, which was glass-ceramics.

### Example 3

The sulfide glass of Example 3 was obtained in the same manner as Comparative Example 1, except that 0.4817 g of Li₂S (manufactured by Furuuchi Chemical Corporation), 0.8444 g of P₂S₅ (manufactured by Aldrich), 0.2712 g of LiI (manufactured by Kojundo Chemical Laboratory Co., Ltd.), 0.2639 g of LiBr (manufactured by Kojundo Chemical Laboratory Co., Ltd.), 0.0212 g of Li₃N (manufactured by Kojundo Chemical Laboratory Co., Ltd.) and 0.1176 g of K₂S (manufactured by Kojundo Chemical Laboratory Co., Ltd.) were used as starting raw materials.

Next, 0.5 g of the obtained sulfide glass of Example 3 was hot-pressed at the first crystallization temperature of the sulfide glass, thereby obtaining the sulfide solid electrolyte material of Example 3, which was glass-ceramics.

### Example 4

The sulfide glass of Example 4 was obtained in the same manner as Comparative Example 1, except that 0.4410 g of Li₂S (manufactured by Furuuchi Chemical Corporation), 0.8889 g of P₂S₅ (manufactured by Aldrich), 0.2854 g of LiI (manufactured by Kojundo Chemical Laboratory Co., Ltd.), 0.2778 g of LiBr (manufactured by Kojundo Chemical Laboratory Co., Ltd.), 0.0557 g of Li₃N (manufactured by Kojundo Chemical Laboratory Co., Ltd.) and 0.0882 g of K₂S (manufactured by Kojundo Chemical Laboratory Co., Ltd.) were used as starting raw materials.

Next, 0.5 g of the obtained sulfide glass of Example 4 was hot-pressed at the first crystallization temperature of the sulfide glass, thereby obtaining the sulfide solid electrolyte material of Example 4, which was glass-ceramics.

### Example 5

The sulfide glass of Example 5 was obtained in the same manner as Comparative Example 1, except that 0.4530 g of Li₂S (manufactured by Furuuchi Chemical Corporation), 0.8428 g of P₂S₅ (manufactured by Aldrich), 0.2706 g of LiI (manufactured by Kojundo Chemical Laboratory Co., Ltd.), 0.2634 g of LiBr (manufactured by Kojundo Chemical Laboratory Co., Ltd.), 0.0528 g of Li₃N (manufactured by Kojundo Chemical Laboratory Co., Ltd.) and 0.1174 g of K₂S (manufactured by Kojundo Chemical Laboratory Co., Ltd.) were used as starting raw materials.

Next, 0.5 g of the obtained sulfide glass of Example 5 was hot-pressed at the first crystallization temperature of the sulfide glass, thereby obtaining the sulfide solid electrolyte material of Example 5, which was glass-ceramics.

### Example 6

The sulfide glass of Example 6 was obtained in the same manner as Comparative Example 1, except that 0.4418 g of Li₂S (manufactured by Furuuchi Chemical Corporation), 0.8221 g of P₂S₅ (manufactured by Aldrich), 0.2640 g of LiI (manufactured by Kojundo Chemical Laboratory Co., Ltd.), 0.2569 g of LiBr (manufactured by Kojundo Chemical Laboratory Co., Ltd.), 0.0515 g of Li₃N (manufactured by Kojundo Chemical Laboratory Co., Ltd.) and 0.1637 g of K₂S (manufactured by Kojundo Chemical Laboratory Co., Ltd.) were used as starting raw materials.

Next, 0.5 g of the obtained sulfide glass of Example 6 was hot-pressed at the first crystallization temperature of the sulfide glass, thereby obtaining the sulfide solid electrolyte material of Example 6, which was glass-ceramics.

### Example 7

The sulfide glass of Example 7 was obtained in the same manner as Comparative Example 1, except that 0.4594 g of Li₂S (manufactured by Furuuchi Chemical Corporation), 0.8053 g of P₂S₅ (manufactured by Aldrich), 0.2586 g of LiI (manufactured by Kojundo Chemical Laboratory Co., Ltd.), 0.2517 g of LiBr(manufactured by Kojundo Chemical Laboratory Co., Ltd.), 0.0202 g of Li₃N (manufactured by Kojundo Chemical Laboratory Co., Ltd.) and 0.2047 g of KI (manufactured by Kojundo Chemical Laboratory Co., Ltd.) were used as starting raw materials.

Next, 0.5 g of the obtained sulfide glass of Example 7 was hot-pressed at the first crystallization temperature of the sulfide glass, thereby obtaining the sulfide solid electrolyte material of Example 7, which was glass-ceramics.

### Example 8

The sulfide glass of Example 8 was obtained in the same manner as Comparative Example 1, except that 0.4349 g of Li₂S (manufactured by Furuuchi Chemical Corporation), 0.7624 g of P₂S₅ (manufactured by Aldrich), 0.2448 g of LiI (manufactured by Kojundo Chemical Laboratory Co., Ltd.), 0.2383 g of LiBr (manufactured by Kojundo Chemical Laboratory Co., Ltd.), 0.0193 g of Li₃N (manufactured by Kojundo Chemical Laboratory Co., Ltd.) and 0.3003 g of KI (manufactured by Kojundo Chemical Laboratory Co., Ltd.) were used as starting raw materials.

Next, 0.5 g of the obtained sulfide glass of Example 8 was hot-pressed at the first crystallization temperature of the sulfide glass, thereby obtaining the sulfide solid electrolyte material of Example 8, which was glass-ceramics.

### Example 9

The sulfide glass of Example 9 was obtained in the same manner as Comparative Example 1, except that 0.4343 g of Li₂S (manufactured by Furuuchi Chemical Corporation), 0.7612 g of P₂S₅ (manufactured by Aldrich), 0.2444 g of LiI (manufactured by Kojundo Chemical Laboratory Co., Ltd.), 0.2379 g of LiBr (manufactured by Kojundo Chemical Laboratory Co., Ltd.), 0.0191 g of Li₃N (manufactured by Kojundo Chemical Laboratory Co., Ltd.) and 0.3032 g of KI (manufactured by Kojundo Chemical Laboratory Co., Ltd.) were used as starting raw materials.

Next, 0.5 g of the obtained sulfide glass of Example 9 was hot-pressed at the first crystallization temperature of the sulfide glass, thereby obtaining the sulfide solid electrolyte material of Example 9, which was glass-ceramics.

For each of the raw materials of the raw material compositions used in Examples 1 to 9, the mass, the mol corresponding thereto, and the mol % when the whole raw material composition was determined as 100 mol %, are shown in Table 2.

TABLE 2

| | Unit | Li₂S | P₂S₅ | LiI | LiBr | Li₃N | K₂S | Kl | total |
|---|---|---|---|---|---|---|---|---|---|
| Example 1 | g | 0.4937 | 0.8654 | 0.2779 | 0.2705 | 0.0217 | 0.0708 | — | 2 |
| | mol | 0.0105 | 0.0019 | 0.0021 | 0.0031 | 0.0006 | 0.0006 | — | 0.0189 |
| | mol % | 55.6 | 10.3 | 11.0 | 16.5 | 3.3 | 3.4 | — | 100 |
| Example 2 | g | 0.4877 | 0.8549 | 0.2745 | 0.2672 | 0.0214 | 0.0942 | — | 1.9999 |
| | mol | 0.0104 | 0.0019 | 0.0021 | 0.0031 | 0.0006 | 0.0009 | — | 0.0189 |
| | mol % | 54.9 | 10.2 | 10.8 | 16.3 | 3.2 | 4.5 | — | 100 |
| Example 3 | g | 0.4817 | 0.8444 | 0.2712 | 0.2639 | 0.0212 | 0.1176 | — | 2 |
| | mol | 0.0103 | 0.0019 | 0.0020 | 0.0030 | 0.0005 | 0.0011 | — | 0.0189 |
| | mol % | 54.3 | 10.0 | 10.7 | 16.1 | 3.2 | 5.6 | — | 100 |
| Example 4 | g | 0.4410 | 0.8889 | 0.2854 | 0.2778 | 0.0557 | 0.0882 | — | 2.037 |
| | mol | 0.0094 | 0.0020 | 0.0021 | 0.0032 | 0.0016 | 0.0008 | — | 0.0191 |
| | mol % | 49.1 | 10.5 | 11.1 | 16.7 | 8.4 | 4.2 | — | 100 |
| Example 5 | g | 0.4530 | 0.8428 | 0.2706 | 0.2634 | 0.0528 | 0.1174 | — | 2 |
| | mol | 0.0095 | 0.0019 | 0.0020 | 0.0030 | 0.0015 | 0.0011 | — | 0.0192 |
| | mol % | 50.3 | 9.9 | 10.5 | 15.8 | 7.9 | 5.6 | — | 100 |
| Example 6 | g | 0.4418 | 0.8221 | 0.2640 | 0.2569 | 0.0515 | 0.1637 | — | 2 |
| | mol | 0.0094 | 0.0018 | 0.0020 | 0.0030 | 0.0015 | 0.0015 | — | 0.0192 |
| | mol % | 49.1 | 9.7 | 10.3 | 15.4 | 7.7 | 7.8 | — | 100 |
| Example 7 | g | 0.4594 | 0.8053 | 0.2586 | 0.2517 | 0.0202 | — | 0.2047 | 1.9999 |
| | mol | 0.0098 | 0.0018 | 0.0019 | 0.0029 | 0.0006 | — | 0.0012 | 0.0182 |
| | mol % | 53.6 | 9.9 | 10.6 | 15.9 | 3.2 | — | 6.8 | 100 |
| Example 8 | g | 0.4349 | 0.7624 | 0.2448 | 0.2383 | 0.0193 | — | 0.3003 | 2 |
| | mol | 0.0093 | 0.0017 | 0.0018 | 0.0027 | 0.0006 | — | 0.0018 | 0.0179 |
| | mol % | 51.7 | 9.6 | 10.2 | 15.3 | 3.1 | — | 10.1 | 100 |
| Example 9 | g | 0.4343 | 0.7612 | 0.2444 | 0.2379 | 0.0191 | — | 0.3032 | 2.0001 |
| | mol | 0.0093 | 0.0017 | 0.0018 | 0.0027 | 0.0005 | — | 0.0018 | 0.0179 |
| | mol % | 51.7 | 9.6 | 10.2 | 15.3 | 3.1 | — | 10.2 | 100 |

### (DTA Measurement)

Differential thermal analysis (DTA) of the sulfide glass of Example 1 was carried out. A TG-DTA device (THERMO PLUS EVO manufactured by Rigaku Corporation) was used for measurement. A sample dish made of aluminum was used, and α-Al₂O₃a powder was used as a reference sample. The DTA was carried out by using the measurement sample of from 20 mg to 26 mg and increasing the temperature from room temperature to 500° C. at 10° C./min in an Ar gas atmosphere. The temperature corresponding to the peak top of the first exothermic peak observed by observing a thus-obtained DTA curve from the low temperature side to the high temperature side of the curve, was read and determined as the first crystallization temperature, and the temperature corresponding to the peak top of the second exothermic peak was read and determined as the second crystallization temperature. Then, temperature difference (Y−X) was calculated. The results are shown in Table 3.

Differential thermal analysis (DTA) of the sulfide glasses of Examples 2 to 9 and Comparative Examples 1 to 9 was carried out in the same manner as Example 1. The results are shown in Table 3.

As shown in Table 1, for the sulfide glasses of Examples 1 to 9, the first crystallization temperature was 171° C. or less, and the temperature difference (Y−X) between the second crystallization temperature Y and the first crystallization temperature X was 75° C. or more. Meanwhile, the sulfide glasses of Comparative Examples 1 to 9 did not satisfy the conditions that the first crystallization temperature is 171° C. or less, and the temperature difference (Y−X) between the second crystallization temperature Y and the first crystallization temperature X is 75° C. or more.

TABLE 3

| | | | | | Primary |
|---|---|---|---|---|---|
| | | | First | Second | crystal |
| | Potassium- | | crystallization | crystallization | stabilization |
| | containing | Presence or | temperature | temperature | temperature |
| | compound | absence of | X | Y | Y − X |
| | species | Li₃N | (° C.) | (° C.) | (° C.) |
| Comparative | — | Absent | 187 | 261 | 74 |
| Example 1 | | | | | |
| Comparative | K₂S | Absent | 183 | 258 | 75 |
| Example 2 | | | | | |
| Comparative | K₂S | Absent | 176 | 241 | 65 |
| Example 3 | | | | | |
| Comparative | K₂S | Absent | 171 | 218 | 47 |
| Example 4 | | | | | |
| Comparative | K₂S | Absent | 168 | 210 | 42 |
| Example 5 | | | | | |
| Comparative | — | Present | 186 | 274 | 88 |
| Example 6 | | | | | |
| Comparative | — | Present | 190 | 283 | 93 |
| Example 7 | | | | | |
| Comparative | — | Present | 193 | 313 | 120 |
| Example 8 | | | | | |
| Comparative | — | Present | 193 | 311 | 118 |
| Example 9 | | | | | |
| Example 1 | K₂S | Present | 162 | 237 | 75 |
| Example 2 | K₂S | Present | 157 | 237 | 80 |
| Example 3 | K₂S | Present | 154 | 239 | 85 |
| Example 4 | K₂S | Present | 171 | 250 | 79 |
| Example 5 | K₂S | Present | 158 | 263 | 105 |
| Example 6 | K₂S | Present | 154 | 256 | 102 |
| Example 7 | KI | Present | 149 | 230 | 81 |
| Example 8 | KI | Present | 145 | 226 | 81 |
| Example 9 | KI | Present | 144 | 231 | 87 |

### (Li Ion Conductivity Measurement)

The Li ion conductivity of the sulfide solid electrolyte material of Example 2 was measured as follows. First, the sample was cold-pressed at a pressure of 4 ton/cm², thereby producing a pellet that was 11.29 mm in diameter and about 500 μm in thickness. Next, the pellet was placed inside a container under an inert atmosphere, which was filled with Ar gas, and SOLARTRON (SI1260) manufactured by Toyo Corporation was used for measurement. Also, the measurement temperature was controlled to 25° C. in a thermostatic bath. As a result, the lithium ion conductivity of the sulfide solid electrolyte material of Example 2 was 2.4 mS/cm.

The Li ion conductivity of the sulfide solid electrolyte material of Comparative Example 8 was measured in the same manner as the sulfide solid electrolyte material of Example 2. As a result, the lithium ion conductivity of the sulfide solid electrolyte material of Comparative Example 8 was 2.5 mS/cm.

Accordingly, the sulfide solid electrolyte material of Example 2, which was obtained by hot-pressing the sulfide glass of Example 2 at the first crystallization temperature thereof, was proved to exhibit the same level of lithium ion conductivity as the sulfide solid electrolyte material of Comparative Example 8, which was obtained by hot-pressing the sulfide glass of Comparative Example 8 at the first crystallization temperature thereof.

According to the method for producing the sulfide solid electrolyte material using the raw material composition of the disclosed embodiments, therefore, even in the case of crystallizing the sulfide glass at a temperature of 171° C. or less, the sulfide solid electrolyte material that exhibits the same level of lithium ion conductivity as the case of crystallizing the sulfide glass at a high temperature of more than 171° C., is thought to be obtained.

1. A method for producing a sulfide solid electrolyte material, the method comprising:
amorphizing a raw material composition containing Li₂S, P₂S₅, LiI, LiBr, a potassium-containing compound and Li₃N to obtain a sulfide glass, and
crystallizing the sulfide glass by hot-pressing the sulfide glass,
wherein, when a first crystallization temperature of the sulfide glass is determined as X, and a second crystallization temperature of the sulfide glass is determined as Y, the first crystallization temperature X of the sulfide glass is 171° C. or less, and a temperature difference (Y−X) between the second crystallization temperature Y and the first crystallization temperature X is 75° C. or more.

2. The method for producing the sulfide solid electrolyte material according to claim 1, wherein the potassium-containing compound is at least one selected from the group consisting of K₂S and KI.

3. The method for producing the sulfide solid electrolyte material according to claim 1, wherein the potassium-containing compound is KI.
